(19) United States
(12) Patent Application Publication
(10) Pub. No.: US 2023/0105736 A1
(43) Pub. Date: Apr. 6, 2023

(54) INTERACTIVE SYSTEM TO ASSIST A USER IN BUILDING A MACHINE LEARNING MODEL

(71) Applicant: THE DUN AND BRADSTREET CORPORATION, Short Hills, NJ (US)

(72) Inventors: Shreyas Raghavan, Chennai (IN); Shankarram Subramanian, Chennai (IN); Karolina Anna Kierzkowski, Westfield, NJ (US); Jahnab Kumar Deka, Guwahati (IN); Chang Lin, Riverside, CT (US)

(73) Assignee: THE DUN AND BRADSTREET CORPORATION, Short Hills, NJ (US)

(21) Appl. No.: 17/945,493

(22) Filed: Sep. 15, 2022

(30) Foreign Application Priority Data
Sep. 15, 2021 (IN) 202141036529
Aug. 8, 2022 (IN) 202241045305

(51) Int. Cl. G06F 18/2415; G06F 18/214; G06F 18/21; G06F 18/23211

(52) U.S. Cl. CPC G06F 18/24155; G06F 18/214; G06F 18/217; G06F 18/23211

(57) ABSTRACT

A method that includes (a) receiving a training dataset, a testing dataset, a number of iterations, and a parameter space of possible parameter values that define a base model, (b) for the number of iterations, performing a parametric search process that produces a report that includes information concerning a plurality of machine learning models, where the parametric search process includes (i) generating a Bayesian optimized parameter space with an option to validate through Stratified Kfold cross validation, where an optimized parameter set includes training data from the training dataset, and testing data from the testing dataset, (ii) running the base model with the final optimized parameter set, thus yielding model results for the plurality of machine learning models, (iii) calculating Kolmogorov-Smirnov (KS) statistics for the model results, and (iv) saving the model results and the KS statistics to the report, and (c) sending the report to a user device.

### CROSS-REFERENCED APPLICATIONS

This application claims priority to Indian Patent Application No. 202141036529, filed on Sep. 15, 2021, and Indian Patent Application No. 202241045305, filed on Aug. 8, 2022, both of which are incorporated herein in their entireties.

### BACKGROUND OF THE DISCLOSURE

### 1. Field of the Disclosure

The present disclosure relates to machine learning, and more particularly, to building a stable, machine learning model through a process that engages in a dialogue with a user to develop the model.

### 2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

In statistics, a Kolmogorov-Smirnov (KS) statistic is a value that indicates the discrimination between targets versus non-targets, where a higher KS indicates better model performance. Risk models are highly important to be stable across multiple samples with their KS statistics and capture rates (decile-based distributions of target, how well model is capturing for top 10% probability and 20% probability). With an advanced machine algorithm there is a risk for overfitting or underfitting on training data. Existing techniques do not support building models with a lower KS difference across samples. For risk use-cases, samples with lower KS differences across them are bound to be more stable and can be used for a longer time period and reduce the need to rebuild models frequently. Also, it is desirable to reduce the complexity of the model by picking out variables that are indicative of the entire data, which in turn helps in lower memory computation and cost for a scoring process.

### SUMMARY

The present disclosure relates to machine learning, and more particularly, to building a stable, machine learning model through a process that engages in a dialogue with a user to develop the model. In this regard, the present disclosure provides an ability for a user to customize a feature selection process according to the user's modelling approach. For example, if the user wants to have a conservative feature selection approach, the cut-off specified can be a higher number (0.8+), this enables the user to see all the variables that are being selected and can also make a manual decision based on a dialogue offered by the process. In addition to feature selection, the model selection allows the user to pick models depending on the KS difference. The process also helps in reducing complexity of the model and provides a stable model across different time periods or samples.

Thus, there is provided a method that includes (a) receiving a training dataset, a testing dataset, a number of iterations, and a parameter space of possible parameter values that define a base model, (b) for the number of iterations, performing a parametric search process that produces a report that includes information concerning a plurality of machine learning models, where the parametric search process includes (i) generating an optimized parameter set for the parameter space, where the optimized parameter set includes training data from the training dataset, and testing data from the testing dataset, (ii) running the base model with the optimized parameter set, thus yielding model results for the plurality of machine learning models, (iii) calculating Kolmogorov-Smirnov (KS) statistics for the model results, and (iv) saving the model results and the KS statistics to the report, and (c) sending the report to a user device.

A method comprising: receiving a training dataset, a testing dataset, a number of iterations, and a parameter space of possible parameter values that define a base model; for the number of iterations, performing a parametric search process that produces a report that includes information concerning a plurality of machine learning models, wherein the parametric search process includes: generating an optimized parameter space using Bayesian optimization approach for the parameter space, wherein an optimized parameter set includes training data from the training dataset, and testing data from the testing dataset; running the base model with the optimized parameter set, thus yielding model results for the plurality of machine learning models; calculating Kolmogorov-Smirnov (KS) statistics for the model results; saving the model results and the KS statistics to the report; and sending the report to a user device.

The method further comprising, prior to performing the parametric search process: obtaining from a user device: an initial dataset; a target variable that contains a name of a dependent variable present in the initial dataset; and optionally, a weight that contains the name of a sample weight variable present in initial dataset; and performing a feature selection process that produces: a correlation table that contains correlation values of correlated pairs; a coverage table that contains a percentage of non-missing values for every feature in the initial dataset; a feature importance table which contains significance of important features with a summary of variance inflation factor to check the correlation between continuous variables and summary of Cramer's V statistics to check the correlation between categorical variables; and an interim dataset that contains an interim list of variables.

The method wherein the interim dataset is a first interim data set, and wherein the method further comprises: sending the first interim data set to the user device; and

receiving from the user device, a second interim dataset that is a modified version of the first interim dataset.

The method further comprising, prior to performing the parametric search process: obtaining an interim dataset and a desired quantity of clusters; and performing a clustering process that produces: a cluster report that contains feature groupings; and an interim list of variables.

The method wherein the number of iterations and the parameter space are specified by a user, via the user device.

The method further comprising, after sending the report to the user device: receiving from the user device, a communication that selects one or more of the machine learning models, thus yielding a selected model; and storing the selected model in a memory device.

A system comprising: at least one processor; and a memory that contains instructions that are readable by the at least one processor to cause the at least one processor to optionally use multiprocessing capability to perform operations of: receiving a training dataset, a testing dataset, a number of iterations, and a parameter space of possible parameter values that define a base model; for the number of iterations, performing a parametric search process that produces a report that includes information concerning a plurality of machine learning models, wherein the parametric search process includes: generating an optimized parameter space using Bayesian optimization approach for the parameter space, wherein an optimized parameter set includes training data from the training dataset, and testing data from the testing dataset; running the base model with the optimized parameter set, thus yielding model results for the plurality of machine learning models; calculating Kolmogorov-Smirnov (KS) statistics for the model results; and saving the model results and the KS statistics to the report; and sending the report to a user device.

The system wherein the operations include, prior to performing the parametric search process: obtaining from a user device: an initial dataset; a target variable that contains a name of a dependent variable present in the initial dataset; and optionally, a weight that contains the name of a sample weight variable present in initial dataset; and performing a feature selection process that produces: a correlation table that contains correlation values of correlated pairs; a coverage table that contains a percentage of non-missing values for every feature in the initial dataset; a feature importance table which contains significance of important features with a summary of variance inflation factor to check the correlation between continuous variables and summary of Cramer's V statistics to check the correlation between categorical variables; and an interim dataset that contains an interim list of variables.

The system wherein the interim dataset is a first interim data set, and wherein the operations further include: sending the first interim data set to the user device; and receiving from the user device, a second interim dataset that is a modified version of the first interim dataset.

The system wherein the operations include, prior to performing the parametric search process: obtaining an interim dataset and a desired quantity of clusters; and performing a clustering process that produces: a cluster report that contains feature groupings; and an interim list of variables.

The system wherein the number of iterations and the parameter space are specified by a user, via the user device.

The system wherein the operations include, after sending the report to the user device: receiving from the user device, a communication that selects one or more of the machine learning models, thus yielding a selected model; and storing the selected model in a memory device.

A storage device comprising instructions that are readable by a processor to cause the processor to perform operations of: receiving a training dataset, a testing dataset, a number of iterations, and a parameter space of possible parameter values that define a base model; for the number of iterations, performing a parametric search process that produces a report that includes information concerning a plurality of machine learning models, wherein the parametric search process includes: generating an optimized parameter space using Bayesian optimization approach for the parameter space, wherein an optimized parameter set includes training data from the training dataset, and testing data from the testing dataset; running the base model with the optimized parameter set, thus yielding model results for the plurality of machine learning models; calculating Kolmogorov-Smirnov (KS) statistics for the model results; and saving the model results and the KS statistics to the report; and sending the report to a user device.

The storage device wherein the operations include, prior to performing the parametric search process: obtaining from a user device: an initial dataset; a target variable that contains a name of a dependent variable present in the initial dataset; and optionally, a weight that contains the name of a sample weight variable present in initial dataset; and performing a feature selection process that produces: a correlation table that contains correlation values of correlated pairs; a coverage table that contains a percentage of non-missing values for every feature in the initial dataset; a feature importance table which contains significance of important features with a summary of variance inflation factor to check the correlation between continuous variables and summary of Cramer's V statistics to check the correlation between categorical variables; and an interim dataset that contains an interim list of variables.

The storage device wherein the interim dataset is a first interim data set, and wherein the operations further include: sending the first interim data set to the user device; and receiving from the user device, a second interim dataset that is a modified version of the first interim dataset.

The storage device of claim 13, wherein the operations include, prior to performing the parametric search process: obtaining an interim dataset and a desired quantity of clusters; and performing a clustering process that produces: a cluster report that contains feature groupings; and an interim list of variables.

The storage device wherein the number of iterations and the parameter space are specified by a user, via the user device.

The storage device wherein the operations include, after sending the report to the user device: receiving from the user device, a communication that selects one or more of the machine learning models, thus yielding a selected model; and storing the selected model in a memory device.

### BRIEF DESCRIPTION OF THE DRAWINGS

FIG. 1 is a block diagram of an interactive system for assisting a user in building a machine learning model.

FIG. 2 is a block diagram of a module that is employed in the system of FIG. 1.

FIG. 3 is a chart that illustrates operations being performed by a user device and the module of FIG. 2, during a communication session.

FIGS. 3A through 3F-1 are representations and examples of messages that are produced during execution of a communication session.

FIGS. 4 and 4(i) are flow charts of operations performed by updated feature selection process.

FIGS. 5 and 5(i) are flowcharts of operations performed by the updated cluster process.

FIGS. 6 and 6(i) are flowcharts of operations performed by the parametric search process.

FIG. 7 is a table of model performance.

FIGS. 8 and8(i) are block diagrams of a flow of information in the system of FIG. 1 during a communication session.

A component or a feature that is common to more than one drawing is indicated with the same reference number in each of the drawings.

### DETAILED DESCRIPTION OF THE PREFERRED EMBODIMENTS

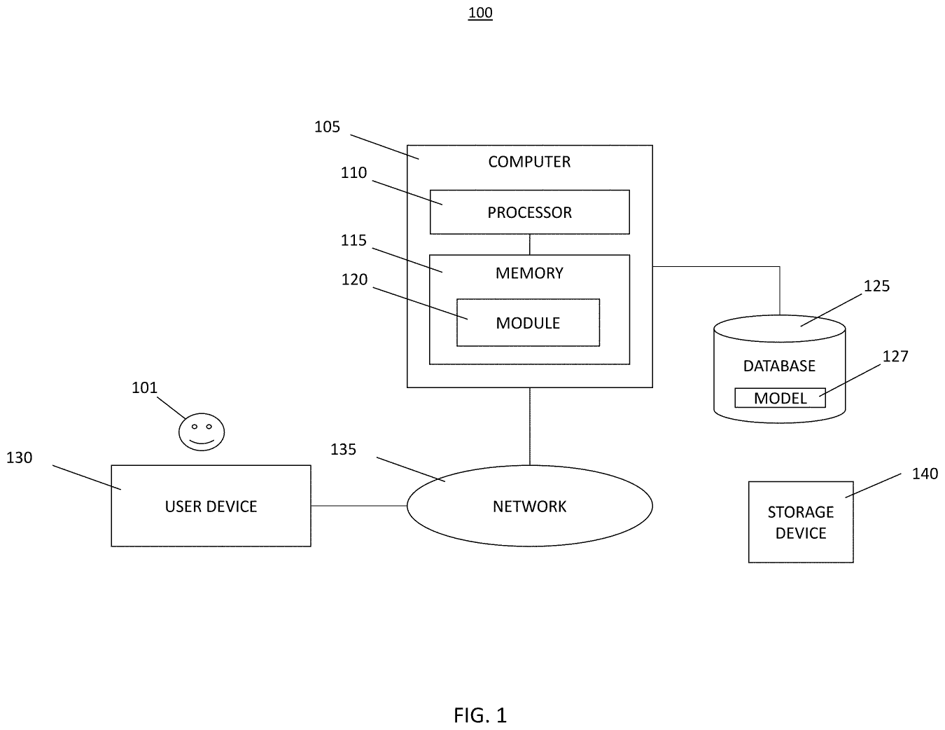

FIG. 1 is a block diagram of an interactive system, namely system 100, for assisting a user 101 in building a machine learning model, namely model 127. System 100 includes a user device 130 and a computer 105 that are communicatively coupled to a network 135. In operation, user 101, through user device 130, engages in a dialogue with computer 105 to build model 127.

Network 135 is a data communications network. Network 135 may be a private network or a public network, and may include any or all of (a) a personal area network, e.g., covering a room, (b) a local area network, e.g., covering a building, (c) a campus area network, e.g., covering a campus, (d) a metropolitan area network, e.g., covering a city, (e) a wide area network, e.g., covering an area that links across metropolitan, regional, or national boundaries, (f) the Internet, or (g) a telephone network. Communications are conducted via network 135 by way of electronic signals and optical signals that propagate through a wire or optical fiber, or are transmitted and received wirelessly.

User device 130 enables user 101 to communicate information to, and receive information from, computer 105 via network 135. User device 130 includes an input device such as a keyboard, speech recognition subsystem, or gesture recognition subsystem. User device 130 also includes an output device such as a display or a speech synthesizer and a speaker. A cursor control or a touch-sensitive screen allows user 101 to utilize user device 130 for communicating additional information and command selections to computer 105.

Computer 105 includes a processor 110 and a memory 115 that is operationally coupled to processor 110. Although computer 105 is represented herein as a standalone device, it is not limited to such, but instead can be coupled to other devices (not shown) in a distributed processing system.

Processor 110 is an electronic device configured of logic circuitry that responds to and executes instructions.

Memory 115 is a tangible, non-transitory, computer-readable storage device. In this regard, memory 115 stores data and instructions, i.e., program code, which are readable and executable by processor 110 for controlling the operation of processor 110. Memory 115 may be implemented in a random-access memory (RAM), a hard drive, a read only memory (ROM), or a combination thereof. One of the components of memory 115 is a program module, namely module 120.

Module 120 contains instructions for controlling processor 110 to execute methods described herein. The term “module” is used herein to denote a functional operation that may be embodied either as a stand-alone component or as an integrated configuration of a plurality of subordinate components. Thus, module 120 may be implemented as a single module or as a plurality of modules that operate in cooperation with one another. Moreover, although module 120 is described herein as being installed in memory 115, and therefore being implemented in software, it could be implemented in any of hardware (e.g., electronic circuitry), firmware, software, or a combination thereof.

While module 120 is indicated as being already loaded into memory 115, it may be configured on a storage device 140 for subsequent loading into memory 115. Storage device 140 is a tangible, non-transitory, computer-readable storage device that stores module 120 thereon. Examples of storage device 140 include (a) a compact disk, (b) a magnetic tape, (c) a read only memory, (d) an optical storage medium, (e) a hard drive, (f) a memory unit consisting of multiple parallel hard drives, (g) a universal serial bus (USB) flash drive, (h) a random-access memory, and (i) an electronic storage device coupled to computer 105 via network 135.

Computer 105 is coupled to a database 125, which is a memory device, e.g., an electronic storage device, that stores data that processor 110 utilizes to perform the methods described herein. Database 125 also stores model 127. Although database 125 is shown as being directly coupled to computer 125, it could be situated in a location that is remote from computer 105 and coupled to computer 105 via network 135. Also, database 125 can be configured as a plurality of databases and storage devices in a distributed storage system. Alternatively, database 125 could be incorporated into memory 115.

Model 127 is built to predict the outcome of an event (e.g., bankruptcy, financial stress, etc.). The process of building model 127 is initiated by user 101 through module 120, and a plurality of prospective machine learning models are built by computer 105. From the prospective models, user 101 selects a model for subsequent use. In practice, database 125 will contain data representing many, e.g., millions of, data items, and the methods described herein involve complex mathematical operations. Thus, in practice, the data items to build the models cannot be processed by a human being, but instead, would require a computer such as computer 105.

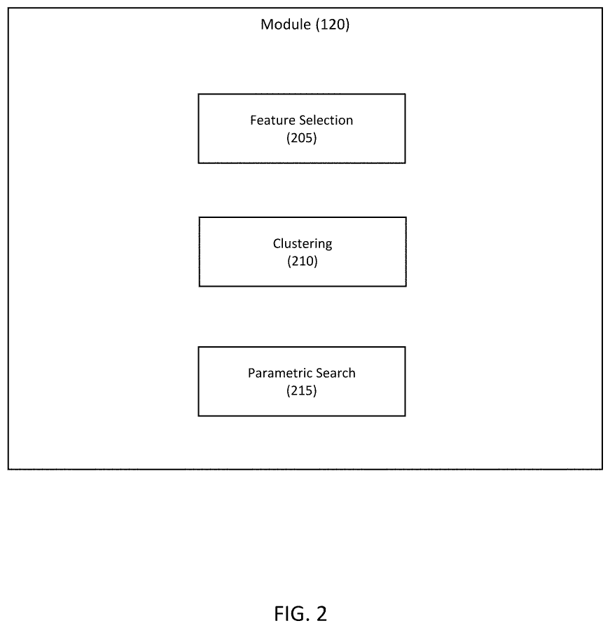

FIG. 2 is a block diagram of module 120. Module 120 is configured of subordinate modules, namely feature selection 205, clustering 210, and parametric search 215.

Feature selection process 205 performs a feature selection process based on multiple approaches, which includes singular value identification, correlation check, important features identification based on LightGBM classifier, variance inflation factor (VIF), and Cramar's V statistics.

Clustering 210 performs variable clustering, which is a process to remove multi-collinearity amongst variables.

Parametric search 215 builds multiple models with different sets of hyper parameters.

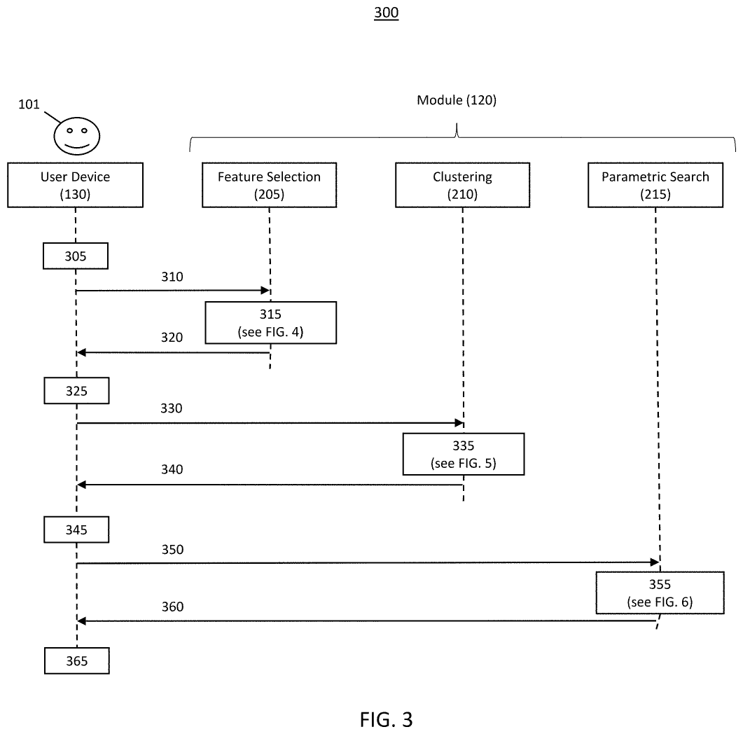

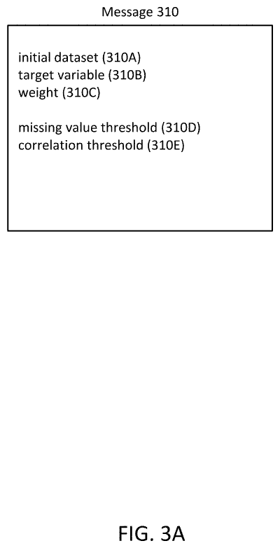

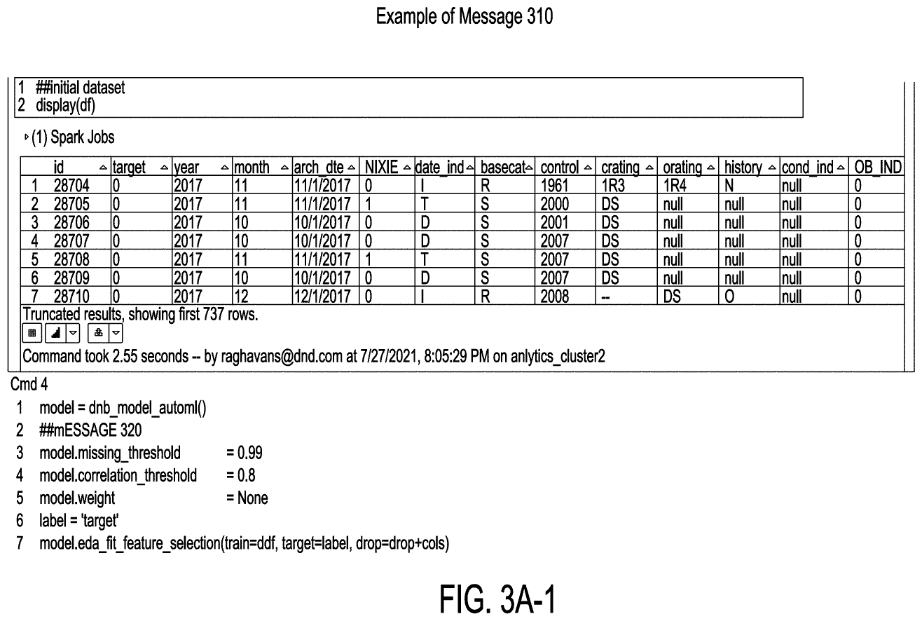

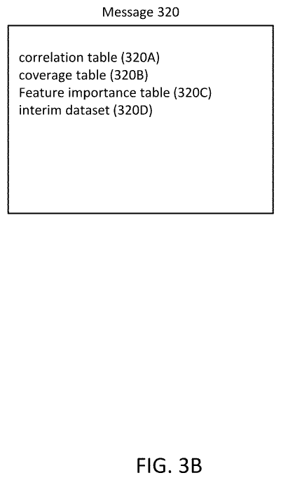

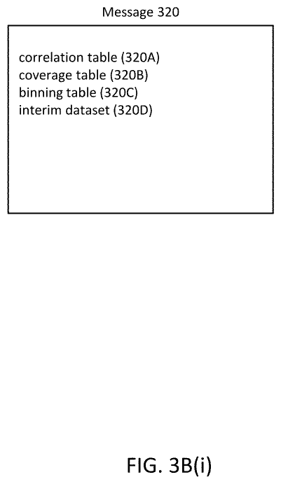

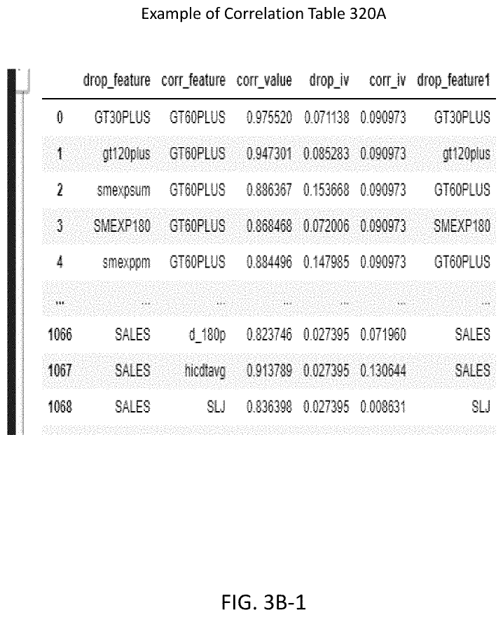

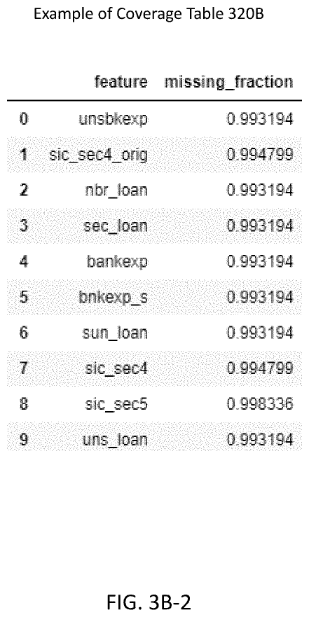

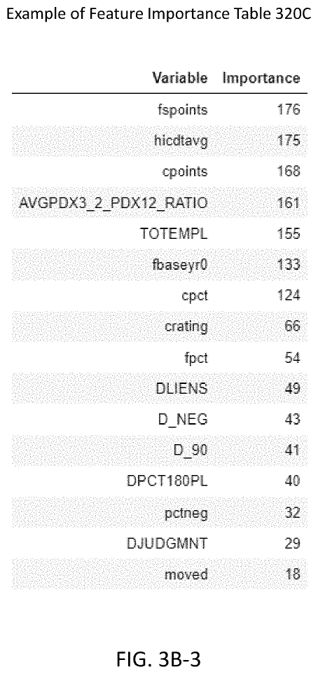

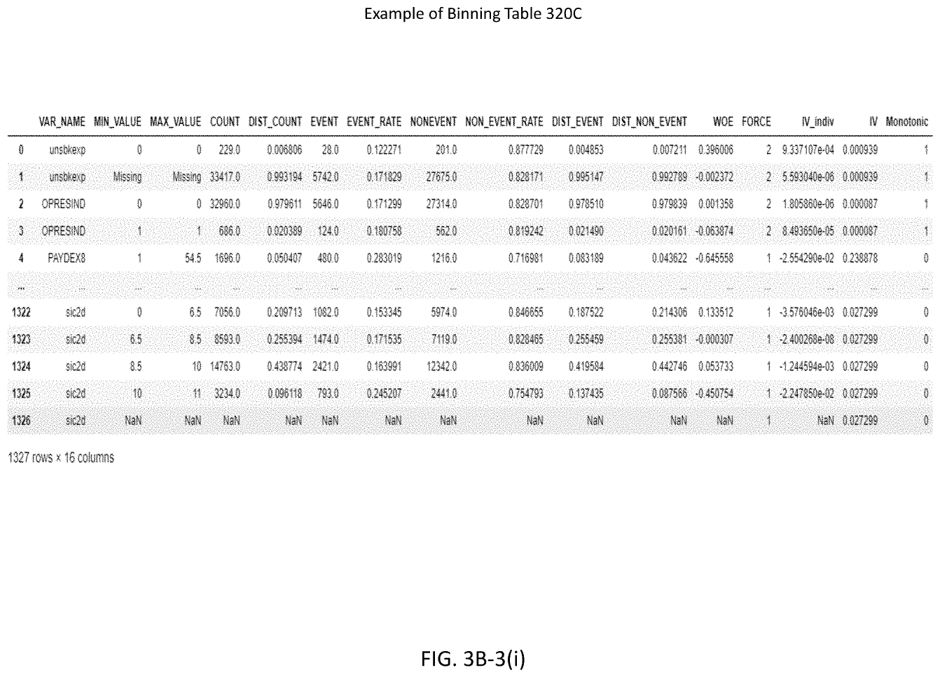

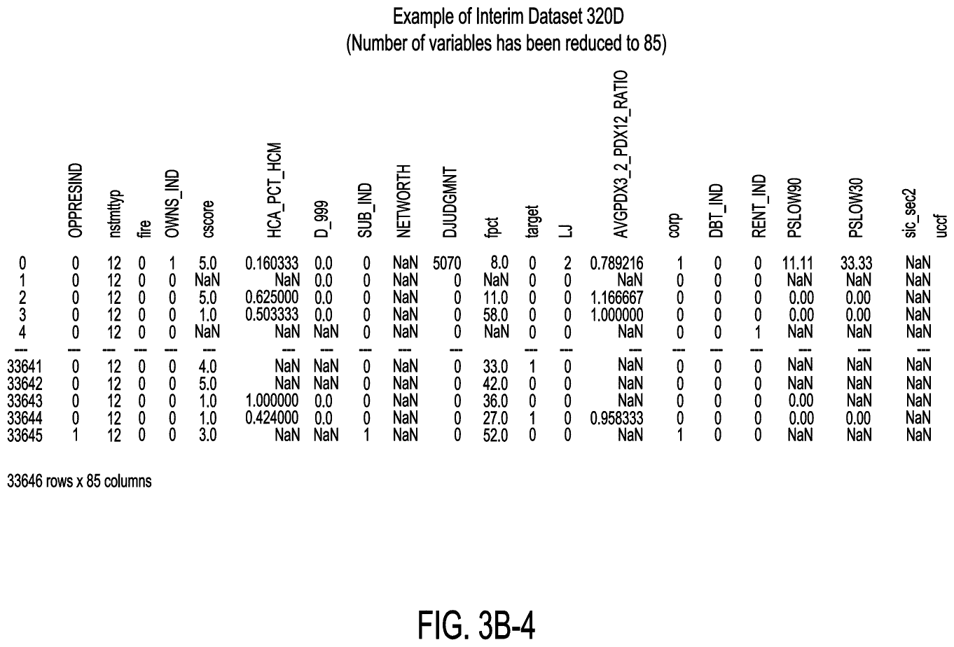

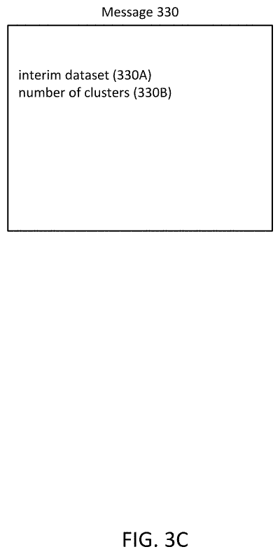

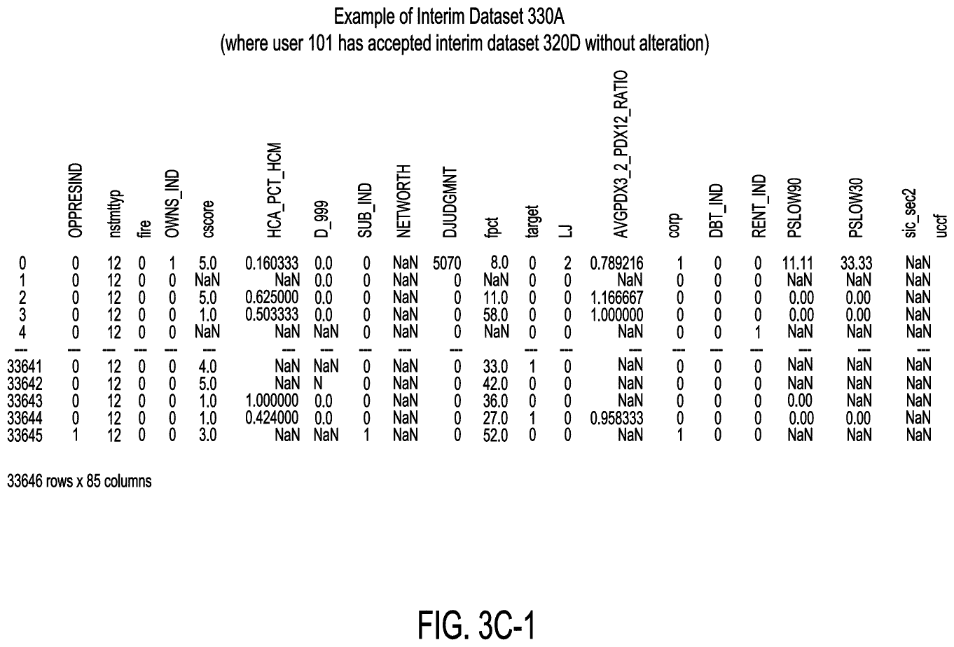

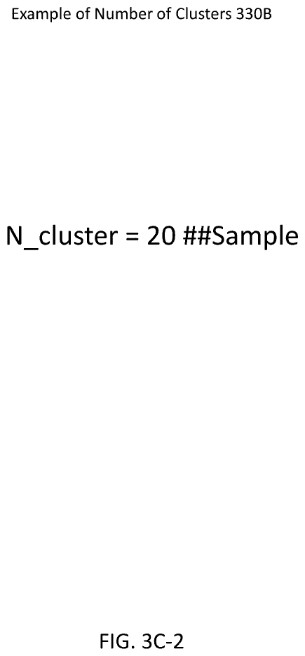

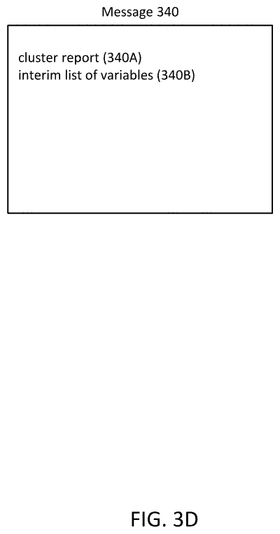

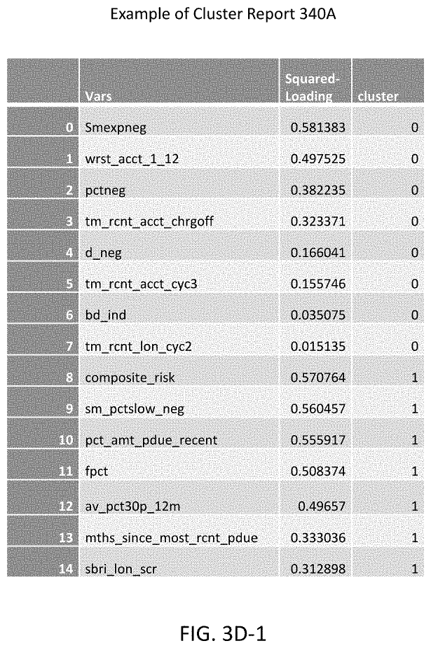

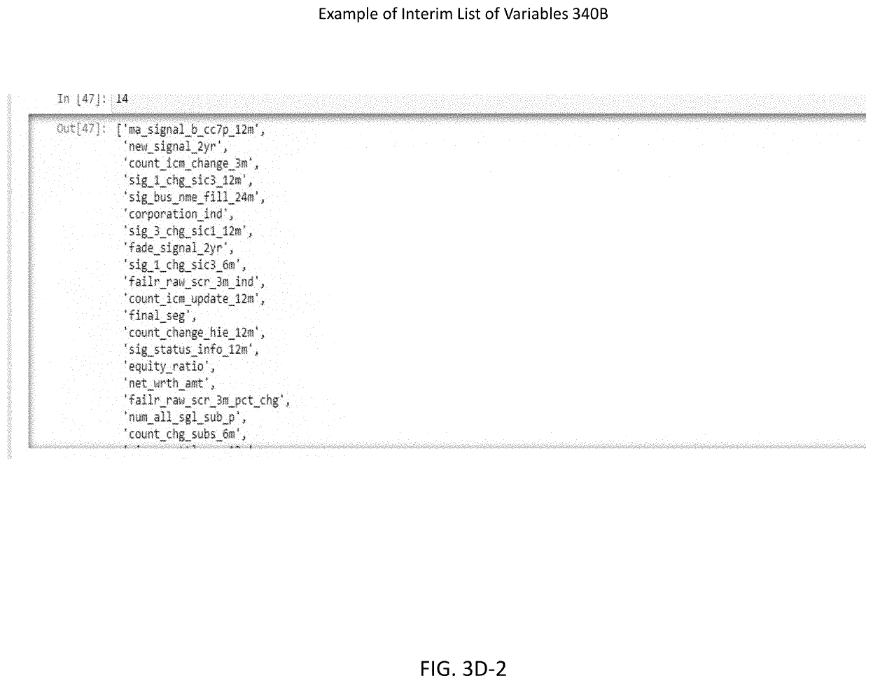

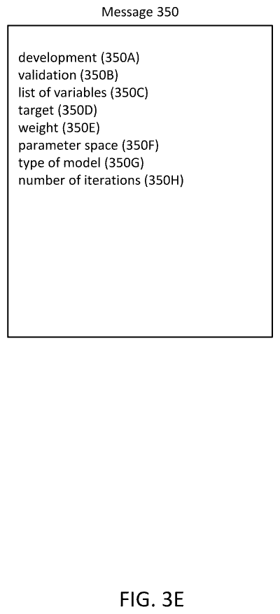

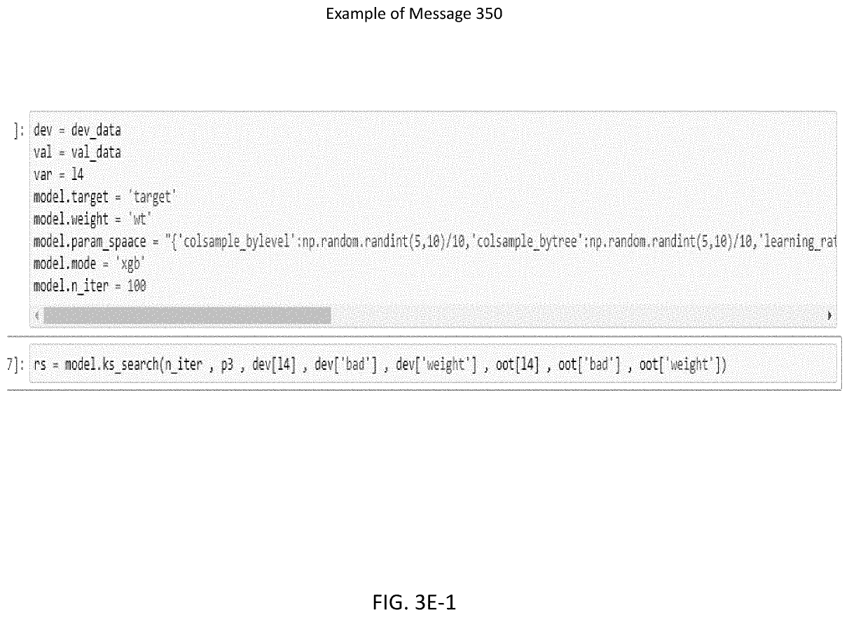

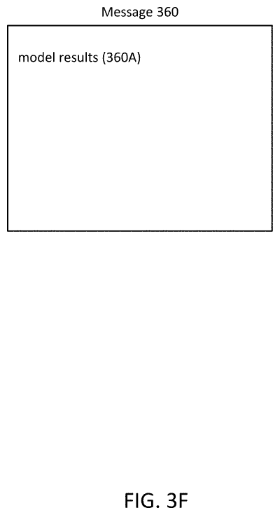

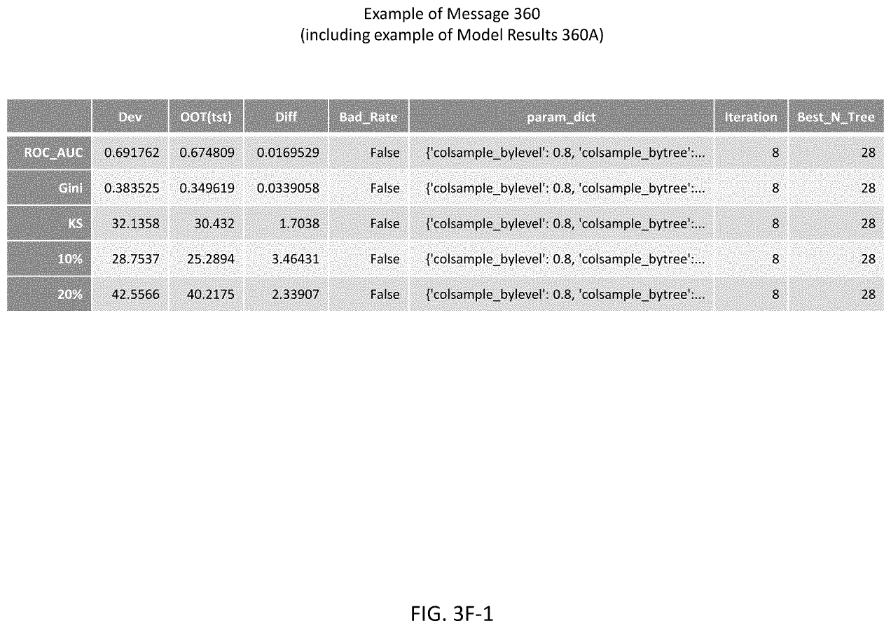

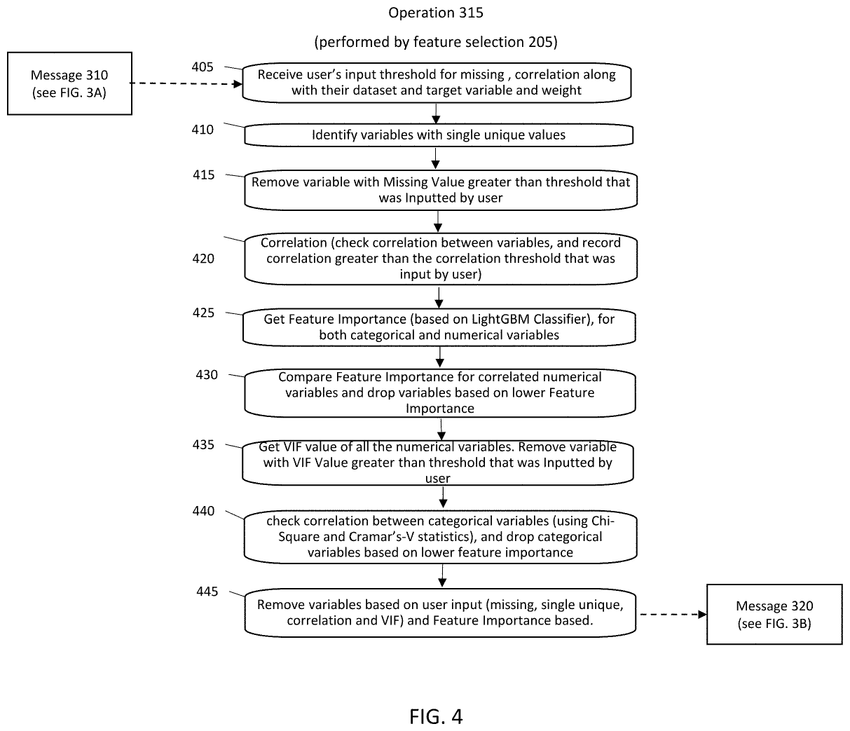

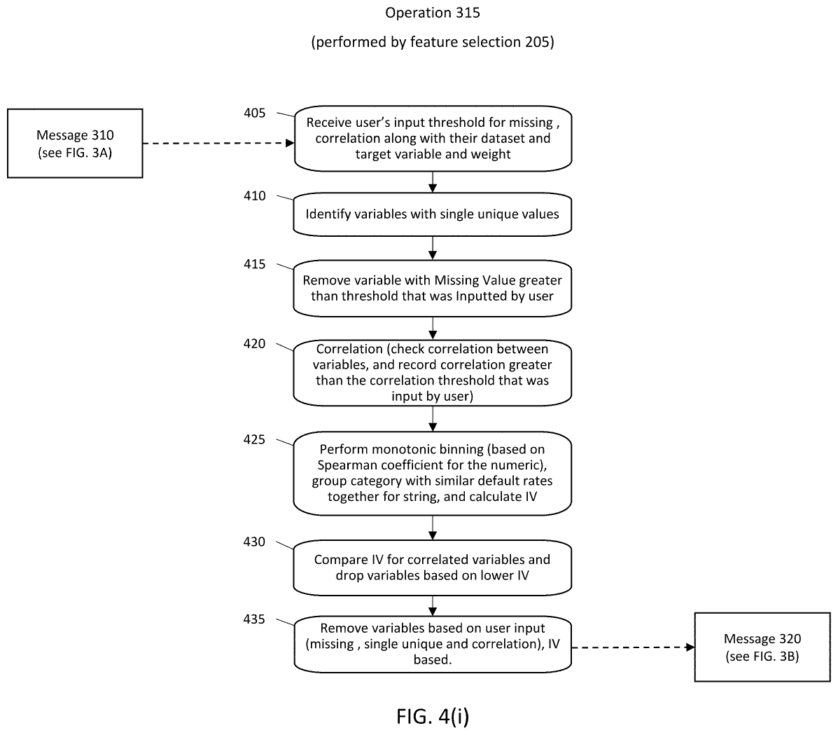

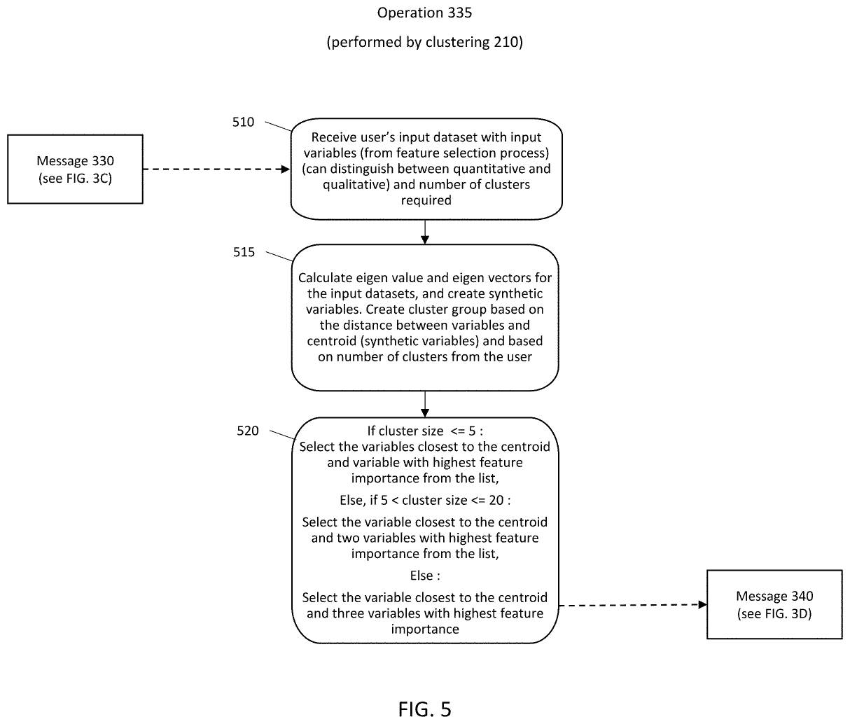

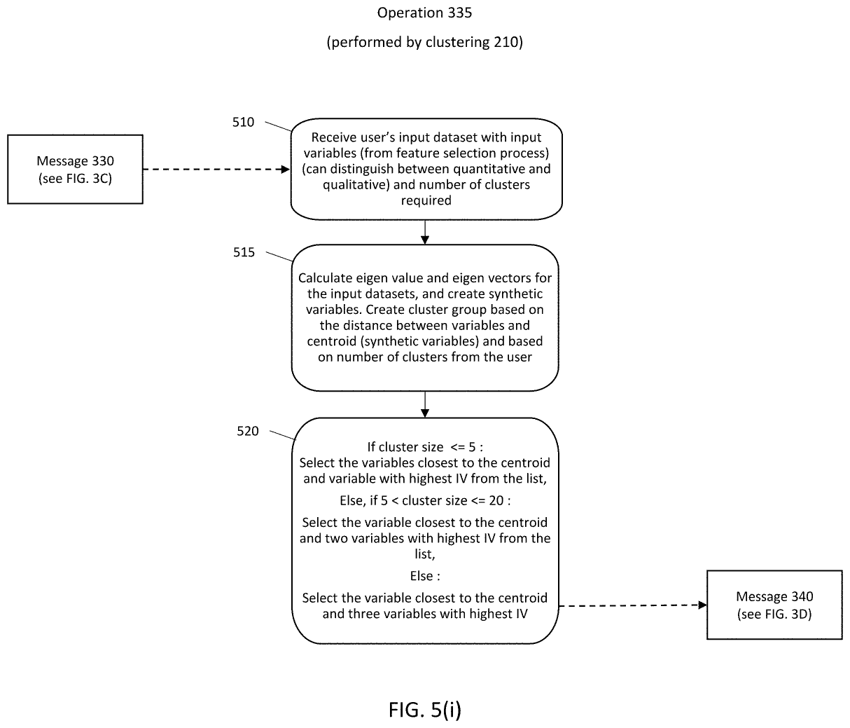

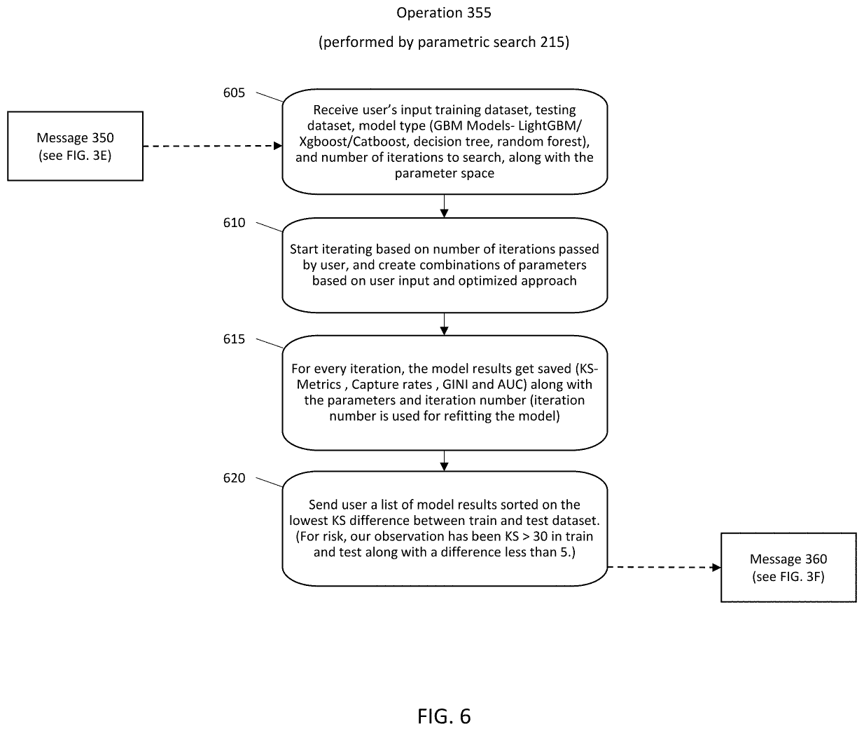

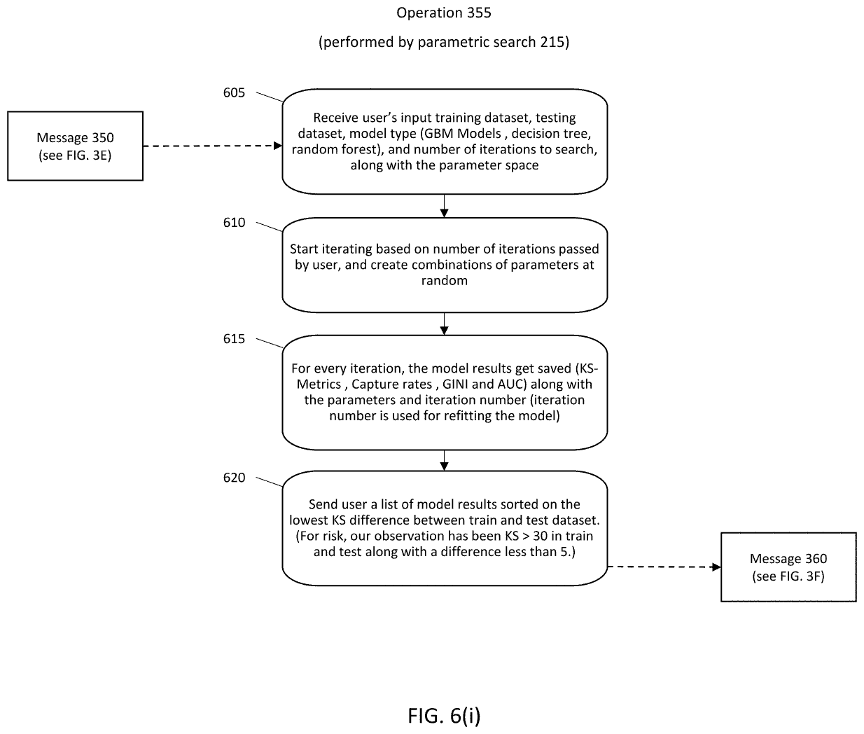

FIG. 3 is a chart that illustrates operations being performed by user device 130 and the aforementioned subordinate modules of module 120, during a communication session, namely session 300, in which user 101 and computer 105 engage in a dialogue with one another. User 101 is operating user device 130, and accordingly, responds to prompts from, and provides information to, computer 105.

FIGS. 3A through 3F-1 are representations and examples of messages that are produced during execution of session 300.

In operation 305, user 101 prepares a message 310, which user device 130 transmits to feature selection 205.

Message 310 is represented in FIG. 3A and includes:
(a) an initial dataset 310A, which is a dataset initialized by user 101 from database 125 onto memory 115;
(b) a target variable 310B, which is a value specified by user 101 that contains the name of a dependent variable present in initial dataset 310A; and
(c) a weight 310C, which is an optional value specified by user 101 that contains the name of a sample weight variable present in initial dataset 310A, and may optionally include:
(d) a missing value threshold 310D, which is a value specified by user 101 to remove variables having a percentage of missing values that is greater than the value specified in missing value threshold 310D; and
(e) a correlation threshold 310E, which is a value specified by user 101 to remove variables having a correlation that is higher than the value specified in correlation threshold 310E.

Initial dataset 310A is available from database 125. In practice, a plurality of such datasets may exist, from which user 101 can select a dataset for use as initial dataset 310A.

FIG. 3A-1 is an example of message 310.

In operation 315, feature selection 205:
(a) receives message 310;
(b) performs a feature selection process based on multiple approaches, which includes singular value identification, correlation check, important features identification based on LightGBM classifier, variance inflation factor (VIF), and Cramar's V statistics;
(c) prepares a message 320; and
(d) transmits message 320 to user device 130.

Message 320 is represented in FIG. 3B and includes:
(a) a correlation table 320A, which contains correlation values of correlated pairs of variables;
(b) a coverage table 320B, which contains a percentage of non-missing values for every feature in initial dataset 310A;
(c) a feature selection table 320C, which contains statistical information and an exploratory data analysis (EDA) summary to check the dependency of variables on target variable 310B; and
(d) an interim dataset 320D, which contains an interim list of variables after execution of operation 315.

FIG. 3B-1 is an example of correlation table 320A.

FIG. 3B-2 is an example of coverage table 320B.

FIG. 3B-3 is an example of feature importance table 320C. FIG. 3B-3(i) is an example of binning table 320C.

FIG. 3B-4 is an example of interim dataset 320D. In this example, the number of variables has been reduced from more than 290 to 85.

Operation 315 is further described below, with reference to FIG. 4.

In operation 325, user 101 has an opportunity to consider and adjust or modify some of the information that was presented in message 320. User 101 prepares a message 330, which user device 130 transmits to clustering 210.

Message 330 is represented in FIG. 3C and includes:
(a) interim dataset 330A, which user 101 prepared by either accepting interim dataset 320D, or adjusting or modifying interim dataset 320D; and
(b) number of clusters 330B, i.e., desired quantity of clusters.

FIG. 3C-1 is an example of interim dataset 330A. In this example, user 101 accepted interim dataset 320D (see FIG. 3B-4) without alteration.

FIG. 3C-2 is an example of number of clusters 330B. In this example, user 101 is specifying that the number of clusters is 20.

In operation 335, clustering 210:
(a) performs variable clustering, which is a process to remove multi-collinearity amongst variables;
(b) prepares a message 340; and
(c) transmits message 340 to user device 130.

Message 340 is represented in FIG. 3D and includes:
(a) a cluster report 340A, which contains the feature groupings; and
(b) an interim list of variables 340B.

FIG. 3D-1 is an example of cluster report 340A.

FIG. 3D-2 is an example of interim list of variables 340B.

Operation 335 is further described below, with reference to FIG. 5.

In operation 345, user 101 has an opportunity to consider and adjust or modify some of the information that was presented in message 340. User 101 prepares a message 350, which user device 130 transmits to parametric search 215.

Message 350 is represented in FIG. 3E and includes:
(a) development data 350A, i.e., training data, which is used for building model 127;
(b) validation data 350B, i.e., testing data, which is used for validating performance of model 127;
(c) list of variables 350C;
(d) target 350D, which represents the name of the target variable;
(e) weight 350E, which represents the name of the variable containing the sample weight;
(f) parameter space 350F, which contains the parameter space of possible parameter values that define a particular machine learning model, e.g., a subset of finite-dimensional Euclidean space;
(g) type of model 350G, which represents the name of the algorithm (e.g., RandomForest, Gradient Boosting, Decision Tree, LightGBM, XGBoost, Catboost); and
(h) number of iterations 350H, which is a number of iterations of a set of operations, namely operations 610 and 615, that will be performed by parametric search 215 to build models. As such, number of iterations 350H also indicates the number, i.e., quantity, of models to be built.

FIG. 3E-1 is an example of message 350.

In operation 355, parametric search 215:
(a) receives message 350;
(b) builds multiple models with different sets of hyper parameters;
(c) prepares message 360; and
(d) transmits message 360 to user device 130.

Message 360 is represented in FIG. 3F and includes model results 360A, which are model results for each iteration.

FIG. 3F-1 is an example of message 360 and includes an example of model results 360A.

Operation 355 is further described below, with reference to FIG. 6.

In operation 365, user 101 selects a model from model results 360A, and the selected model is stored as model 127 in database 125, from where it can be subsequently obtained for further use. In practice, the selected model should be based on lower KS and capture rate difference between training and test sample. User 101 can input the iteration number, which also serves as a model identifier, to obtain the selected model.

FIG. 4 is a flowchart of operation 315, which is performed by feature selection process 205. As mentioned above, in the description of FIG. 3, in operation 315, feature selection 205 performs a feature selection process based on multiple approaches, which includes singular value identification, correlation check, important features identification based on LightGBM classifier, variance inflation factor (VIF), and Cramar's V statistics. FIG. 4(i) is a flowchart of operation 315, which is performed by feature selection process 205. As mentioned above, in the description of FIG. 3, in operation 315, feature selection 205 performs a feature selection process based on multiple approaches, which includes singular value identification, correlation check, and information value (1V) computation through monotonic binning.

In operation 405, from message 310, feature selection 205 obtains initial dataset 310A, target variable 310B and weight 310C, and if provided, missing value threshold 310D and correlation threshold 310E.

In operation 410, feature selection 205 identifies variables with single unique values. Variables having only one unique value across the dataset are identified for removal because in modelling, singular values are not considered, since a single value across a data set cannot help in predictions.

In operation 415, if user 101 provided missing value threshold 310D in message 310, feature selection 205 removes variable(s) with missing values greater than missing value threshold 310D. Feature selection 205 calculates a missing value percentage and stores a list of variables having missing values greater than missing value threshold 310D. A variable having a higher missing value is not considered as an ideal variable since the variable would not provide any information for predicting a target. Missing value threshold 310D is the defined threshold to drop variables containing a percentage of missing values above the threshold. Thus, in operation 415, variables having a missing value percentage higher than missing value threshold 310D are dropped. Non-missing values are recorded in coverage table 320B.

In operation 420, if user 101 provided correlation threshold 310E in message 310, feature selection 205 performs a correlation. Feature selection 205 checks a correlation between variables, and records variables having a correlation greater than correlation threshold 310E. If the correlation value of a pair of variables is higher than correlation threshold 310E, then the pair of variables is recorded in correlation table 320A.

In operation 425, feature selection 205 performs feature importance identifications based on LightGBM classifier which handles both numerical and categorical variables without any additional operation required to performed for categorical variables. This information is recorded in feature importance table 320C. This information from 425 is used for further variable selection in operation in 430.

In operation 430, feature selection 205 compares feature importance for correlated variables, and drops variables based on lower feature importance.

In operation 435, feature selection 205 checks the VIF value of all the numerical variables and removes variables having a higher VIF value greater than the threshold value that was inputted by user (if any).

In operation 440, feature selection 205 checks correlation between categorical variables using Chi-Square and Cramar's V statistics, and compares the feature importance obtained from 320C and drops the categorical variables based on lower feature importance.

In operation 445, feature selection 205 removes variables identified from operations 410, 415, 430, 435 and 440, based on message 310.

In message 320, and more particularly, in tables within message 320, feature selection 205 transmits, to user device 130, missing, single unique value, correlation, binning, and feature importance.

FIG. 5 is a flowchart of operation 335, which is performed by clustering 210. As mentioned above, in the description of FIG. 3, in operation 335, clustering 210 performs variable clustering, which is a process to remove multi-collinearity amongst variables. FIG. 5(i) is a flowchart of operation 335, which is performed by clustering 210. As mentioned above, in the description of FIG. 3, in operation 335, clustering 210 performs variable clustering, which is a process to remove multi-collinearity amongst variables.

In operation 510, clustering 210 obtains the inputs from message 330, represented in FIG. 3C.

In operation 515, clustering 210 creates centroids and distances of variables from the centroid. Clustering 210 calculates Eigen values and Eigen vectors for the for interim dataset 320D, creates synthetic variables, and creates cluster groups based on the distance between variables and centroid (synthetic variables), and based on number of clusters 330B. In operation 515, variable clustering is performed, and clusters are created representing similar variables.

In operation 520, clustering 210 prepares cluster report 340A, which contains feature groupings. A feature grouping is a list of cluster groups with their distances from centroid. Clustering 210 employs the following logic.

If cluster size <=5:
Select the variables closest to the centroid and variable with highest feature importance from the list,

Else, if 5<cluster size <=20:
Select the variable closest to the centroid and two variables with highest feature importance from the list,

Else:
Select the variable closest to the centroid and three variables with highest feature importance.

In operation 520, clustering 210 also prepares interim list of variables 340B from the cluster groupings based on how close they are to the centroid, and variables with higher feature importance value are selected based on the rules, i.e., logic/equations, specified above.

Thus, clustering 210 compares distance to centroid and information value for the variables, and outputs message 340 containing cluster report 340A and interim list of variables 340B.

FIG. 6 is a flowchart of operation 355, which is performed by parametric search 215. As mentioned above, in operation 355, parametric search 215 builds multiple models with different sets of hyper parameters. FIG. 6(i) is a flowchart of operation 355, which is performed by parametric search 215. As mentioned above, in operation 355, parametric search 215 builds multiple models with different sets of hyper parameters.

In operation 605, inputs from message 350 are initialized, i.e., set to some desired initial values. Parametric search 215 receives development data 350A, validation data 350B, list of variables 350C, target 350D, weight 350E, parameter space 350F, i.e., parameter space for the model, model type 350G (e.g., gradient boosting models, decision tree, random forest), and number of iterations 350H. Development data 350A is training data. Validation data 350B is testing data.

In operation 610, model development takes place, wherein models are created for each parameter combination. Parametric search 215 performs an optimized search of parameter space 350F. That is, parametric search 215 generates an optimized parameter set based on parameter space 350F and trains the model on it. Parametric search 215 starts iterating based on number of iterations 350H, which was provided by user 101 in message 350, and creates combinations of parameters. In operation 610, parameters from parameter space 350F and models are initialized.

In operation 615, performance metrics of the models are recorded. Parametric search 215 runs iterations on parameter space 350F while using early stopping. The models are built, and key metrics and information such as KS, Gini, 10% and 20% capture rates, parameters and iteration number for each model are captured and stored in a table as a part of model results 360A. In operation 615, models are built based on the parameters initialized in operation 610.

In operation 620, in message 360, parametric search 215 returns, to user device 130, a table with the information from operation 615. User 101 receives a list of model results sorted on the lowest KS difference between train and test dataset. For risk, our observation has been KS >30 in train and test along with a difference less than 5. In operation 620, the model statistics are saved, so they can be subsequently used to pick the appropriate model based on the KS and capture rates.

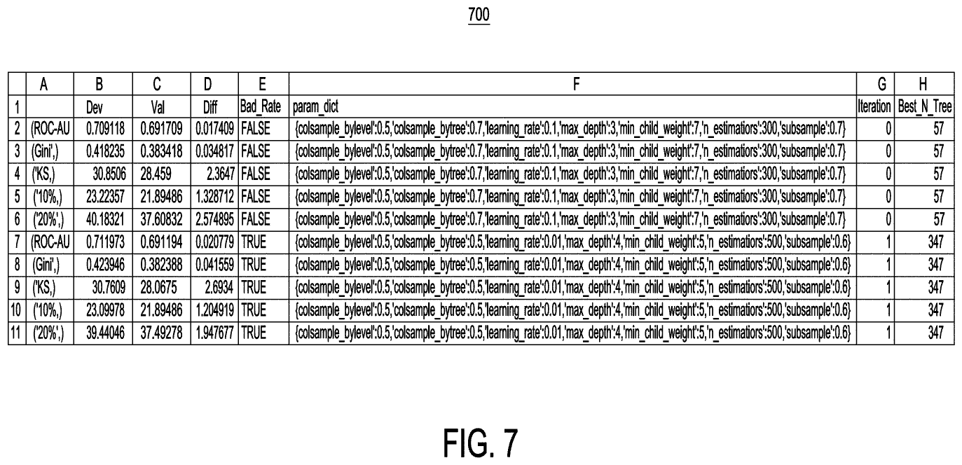

FIG. 7 is a table 700 of model performance outputted as a part of message

In table 700, each row contains information pertaining to a key metric, and the columns are defined as:
A name of the key metric
B development (training data)
C validation (testing data)
D difference between column A and column B
E bad rate
F parameters
G iteration
H best number of trees

Table 700 includes KS statistics, see rows 4 and 9.

A bad rate, i.e., column E, being TRUE is indicative of a stable model.

Iteration, i.e., column G, is a convenient identifier of a model number. For example, iteration 0 corresponds to model number 0, and iteration 1 corresponds to model number 1. Thus, rows 2 through 6 are providing information about model number 0, and rows 7 through 11 are providing information about model number 1.

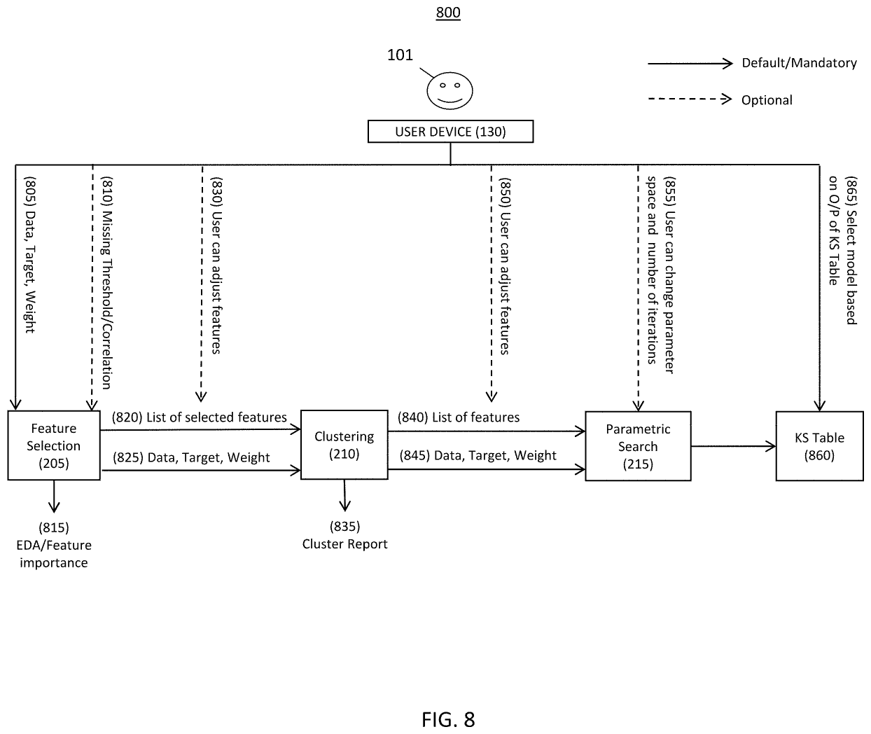

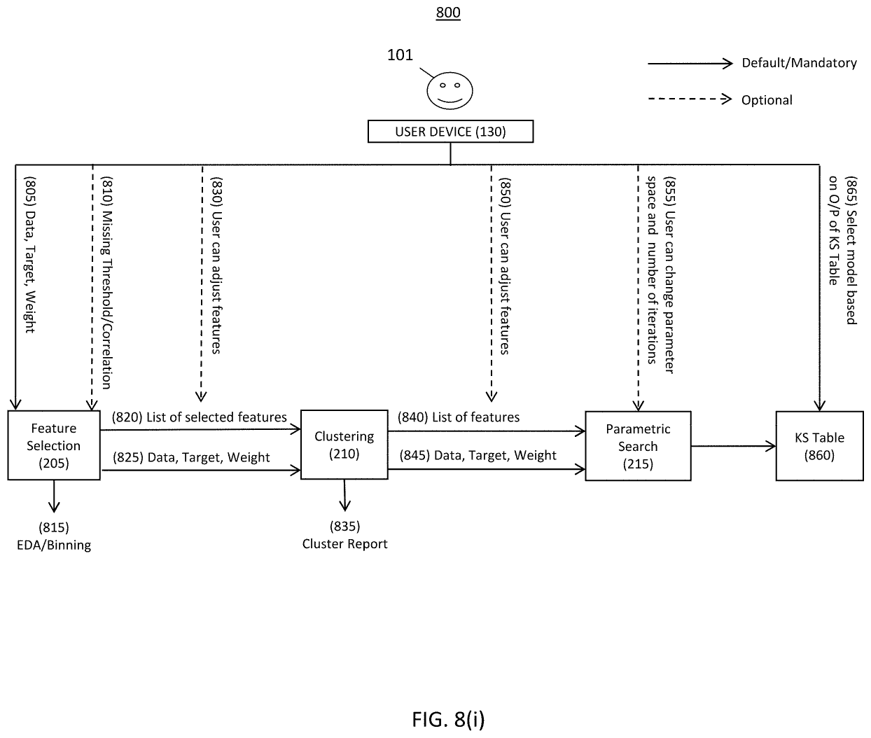

FIG. 8 is a block diagram of a flow of information in system 100 during a communication session, namely session 800, in which user 101 and computer 105 engage in a dialogue with one another. Session 800 is similar to session 300, but provides an alternative visualization of communications to what is shown in session 300. Accordingly, when describing session 800, we will refer to corresponding operations and messages of session 300. Also, session 800 shows that several items of information that are represented in session 300 are optional. Default/mandatory items of information are represented with a solid line. Optional information is represented with a dashed line.

In a message 805, user 101 sends data, target, and weight (optional) to feature selection 205, and in a message 810, user 101 sends missing threshold and correlation to feature selection 205. Message 805 contains mandatory information, and is analogous to initial dataset 310A, target variable 310B, and weight 310C. Message 810 contains optional information and is analogous to missing value threshold 310D and correlation threshold 310E.

In session 800, feature selection 205 prepares EDA/feature importance 815, list of selected features 820, and data, target, weight 825. EDA/feature importance 815 is analogous to correlation table 320A, coverage table 320B and feature importance table 320C. List of selected features 820, and data, target, weight 825 are, collectively, analogous to interim dataset 320D, and in session 800, are provided from feature selection 205 to clustering 210.

Alternatively, as shown in FIG. 8(i) and in session 800, feature selection 205 prepares EDA/binning 815, list of selected features 820, and data, target, weight 825. EDA/binning 815 is analogous to correlation table 320A, coverage table 320B and binning table 320C. List of selected features 820, and data, target, weight 825 are, collectively, analogous to interim dataset 320D, and in session 800, are provided from feature selection 205 to clustering 210.

In a message 830, user 101 can adjust features in list of selected features 820. Message 830 is analogous to message 330.

In session 800, clustering 210 uses 1-R² score and feature importance from feature selection 205 to generate final features. In this regard, clustering 210 prepares cluster report 835, list of features 840 and data, target, weight 845. Cluster report 835 is analogous to cluster report 340A. List of features 840 and data, target, weight 845, collectively, are analogous to interim list of variables 340B, and in session 800, are provided from clustering 210 to parametric search 215.

In a message 850, user 101 can adjust the content of list of features 840, and in a message 850 user 101 can change a parameter space and specify the number of iterations that parametric search 215 will perform. Messages 850 and 855, collectively, are analogous to message 350.

In session 800, parametric search 215 builds a machine learning model based on parameters that it receives from clustering 210, namely list of features 840 and data, target, weight 845, which user 101 has an opportunity to modify via messages 850 and 855. In session 800, parametric search generates the machine learning model in the form of a KS table 860. KS table 860 is similar, in form, to table 700.

In operation 865, user 101 selects a model from KS table 860. The selected model is stored as model 127. Operation 865 is analogous to operation 365.

In review of system 100:
(a) In operation 305, user 101 initializes the missing value threshold, correlation threshold, target variable and sample weights and data present in memory 115. The above initialization is passed as an input to feature selection 205 as a part of message 310.
(b) In operation 315, feature selection 205 performs operation steps as described in FIG. 4, and returns the set of filtered variables from feature selection 205 as a part of message 320.
(c) In operation 325, user 101 initializes data, number of clusters with the set of variables returned through message 320, and this initialization is passed onto clustering 210 as message 330.
(d) In operation 335, clustering 210 performs variable clustering as described in FIG. 5. User 101 receives a set of filtered variables in message 340.
(e) In operation 345, user 101 initializes development and validation sample with the list of variables received in message 340, along with the target variable, number of iterations, type of model, parameter space and sample weights. This is then inputted to parametric search 215 as message 350.
(f) In operation 355, parametric search 215 performs model development and parameter search as described in FIG. 6, and in message 360, user 101 receives output of models built by parametric search 215, as shown, for example, in table 700.
(g) User 101 can select the model based on KS difference between development and validation sample and select the model based on the iteration number, as displayed, for example, in table 700.

Thus, system 100 interactively enables user 101 to build stable risk models with a lower number of features, hence reducing the complexity/cost of the model deployment.

In system 100, user 101 can load data from database 125 containing the financial information of companies. User 101 can build a machine learning model using module 120 to predict an event (e.g., bankruptcy, financial stress, fraud, etc.). User 101 can pass message 310 onto feature selection 205 to record basic statistics and select features to reduce the complexity of the model and improve the computational efficiency during the model development process. User 101 can further increase the computational efficiency by passing message 330 to clustering 210. User 101 can build a stable model in an automated manner by passing the message 350 to parametric search 215. User 101 can select the model based on iteration number through the output from message 360.

System 100 provides benefits such as:
(a) Significantly reducing the time to develop a machine learning model. System 100 builds multiple models, validates their performance, and determines the best predictors.
(b) Optimizing a training and validation strategy, which allows for finding the best performance model, while achieving modeling objectives and requirements of model stability over time.
(c) Allowing a user to select significant features, which then result in reducing processing time of workflow. As an example, an initial input file considered 600 attributes, but during a selection and file criteria, only 150 make it into the training procedures. The amount of memory and processing time to handle training on fewer attributes provides quicker execution of the training process.
(d) During development, we were able to deliver a machine learning solution with 1-2 days training results on portfolios, instead of manually trying multiple options and manually searching for best parameters, which would ordinarily take 1-2 weeks.
(e) Being reused on more than one case where an objective is to build a predictive model on a binary classification target, i.e., yes/no.

The techniques described herein are exemplary and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

Feature 1—A method comprising: receiving a training dataset, a testing dataset, a number of iterations, and a parameter space of possible parameter values that define a base model; for said number of iterations, performing a parametric search process that produces a report that includes information concerning a plurality of machine learning models, wherein said parametric search process includes: generating a random parameter set for said parameter space, wherein said random parameter set includes training data from said training dataset, and testing data from said testing dataset; running said base model with said random parameter set, thus yielding model results for said plurality of machine learning models; calculating Kolmogorov-Smirnov (KS) statistics for said model results; and saving said model results and said KS statistics to said report; and sending said report to a user device.

Feature 2—The method of feature 1, further comprising, prior to performing said parametric search process: obtaining from a user device: an initial dataset; a target variable that contains a name of a dependent variable present in said initial dataset; and a weight that contains the name of a sample weight variable present in initial dataset; and performing a feature selection process that produces: a correlation table that contains correlation values of correlated pairs; a coverage table that contains a percentage of non-missing values for every feature in said initial dataset; a binning table that contains statistical information and an exploratory data analysis (EDA) summary; and an interim dataset that contains an interim list of variables.

Feature 3—The method of feature 2, wherein said interim dataset is a first interim data set, and wherein said method further comprises: sending said first interim data set to said user device; and receiving from said user device, a second interim dataset that is a modified version of said first interim dataset.

Feature 4—The method of feature 1, further comprising, prior to performing said parametric search process: obtaining an interim dataset and a desired quantity of clusters; and performing a clustering process that produces: a cluster report that contains feature groupings; and an interim list of variables.

Feature 5—The method of feature 1, wherein said number of iterations and said parameter space are specified by a user, via said user device.

Feature 6—The method of feature 1, further comprising, after sending said report to said user device: receiving from said user device, a communication that selects one or more of said machine learning models, thus yielding a selected model; and storing said selected model in a memory device.

Feature 7—A system comprising: a processor; and a memory that contains instructions that are readable by said processor to cause said processor to perform operations of: receiving a training dataset, a testing dataset, a number of iterations, and a parameter space of possible parameter values that define a base model; for said number of iterations, performing a parametric search process that produces a report that includes information concerning a plurality of machine learning models, wherein said parametric search process includes: generating a random parameter set for said parameter space, wherein said random parameter set includes training data from said training dataset, and testing data from said testing dataset; running said base model with said random parameter set, thus yielding model results for said plurality of machine learning models; calculating Kolmogorov-Smirnov (KS) statistics for said model results; and saving said model results and said KS statistics to said report; and sending said report to a user device.

Feature 8—The system of feature 7, wherein said operations include, prior to performing said parametric search process: obtaining from a user device: an initial dataset; a target variable that contains a name of a dependent variable present in said initial dataset; and a weight that contains the name of a sample weight variable present in initial dataset; and performing a feature selection process that produces: a correlation table that contains correlation values of correlated pairs; a coverage table that contains a percentage of non-missing values for every feature in said initial dataset; a binning table that contains statistical information and an exploratory data analysis (EDA) summary; and an interim dataset that contains an interim list of variables.

Feature 9—system of feature 8, wherein said interim dataset is a first interim data set, and wherein said operations further include: sending said first interim data set to said user device; and receiving from said user device, a second interim dataset that is a modified version of said first interim dataset.

Feature 10—system of feature 7, wherein said operations include, prior to performing said parametric search process: obtaining an interim dataset and a desired quantity of clusters; and performing a clustering process that produces: a cluster report that contains feature groupings; and an interim list of variables.

Feature 11—system of feature 7, wherein said number of iterations and said parameter space are specified by a user, via said user device.

Feature 12—system of feature 7, wherein said operations include, after sending said report to said user device: receiving from said user device, a communication that selects one or more of said machine learning models, thus yielding a selected model; and storing said selected model in a memory device.

Feature 13—A storage device comprising instructions that are readable by a processor to cause said processor to perform operations of: receiving a training dataset, a testing dataset, a number of iterations, and a parameter space of possible parameter values that define a base model; for said number of iterations, performing a parametric search process that produces a report that includes information concerning a plurality of machine learning models, wherein said parametric search process includes: generating a random parameter set for said parameter space, wherein said random parameter set includes training data from said training dataset, and testing data from said testing dataset; running said base model with said random parameter set, thus yielding model results for said plurality of machine learning models; calculating Kolmogorov-Smirnov (KS) statistics for said model results; and saving said model results and said KS statistics to said report; and sending said report to a user device.

Feature 14—storage device of feature 13, wherein said operations include, prior to performing said parametric search process: obtaining from a user device: an initial dataset; a target variable that contains a name of a dependent variable present in said initial dataset; and a weight that contains the name of a sample weight variable present in initial dataset; and performing a feature selection process that produces: a correlation table that contains correlation values of correlated pairs; a coverage table that contains a percentage of non-missing values for every feature in said initial dataset; a binning table that contains statistical information and an exploratory data analysis (EDA) summary; and an interim dataset that contains an interim list of variables.

Feature 15—storage device of feature 14, wherein said interim dataset is a first interim data set, and wherein said operations further include: sending said first interim data set to said user device; and receiving from said user device, a second interim dataset that is a modified version of said first interim dataset.

Feature 16—storage device of feature 13, wherein said operations include, prior to performing said parametric search process: obtaining an interim dataset and a desired quantity of clusters; and performing a clustering process that produces: a cluster report that contains feature groupings; and an interim list of variables.

Feature 17—storage device of feature 13, wherein said number of iterations and said parameter space are specified by a user, via said user device.

Feature 18—storage device of feature 13, wherein said operations include, after sending said report to said user device: receiving from said user device, a communication that selects one or more of said machine learning models, thus yielding a selected model; and storing said selected model in a memory device.

The terms “comprises” or “comprising” are to be interpreted as specifying the presence of the stated features, integers, steps, or components, but not precluding the presence of one or more other features, integers, steps or components or groups thereof. The terms “a” and “an” are indefinite articles, and as such, do not preclude embodiments having pluralities of articles.

What is claimed is:

1. A method comprising:
receiving a training dataset, a testing dataset, a number of iterations, and a parameter space of possible parameter values that define a base model;
for said number of iterations, performing a parametric search process that produces a report that includes information concerning a plurality of machine learning models, wherein said parametric search process includes:
generating an optimized parameter space using Bayesian optimization approach for said parameter space, wherein an optimized parameter set includes training data from said training dataset, and testing data from said testing dataset;
running said base model with said optimized parameter set, thus yielding model results for said plurality of machine learning models;
calculating Kolmogorov-Smirnov (KS) statistics for said model results; and
saving said model results and said KS statistics to said report; and
sending said report to a user device.

2. The method of claim 1, further comprising, prior to performing said parametric search process:
obtaining from a user device:
an initial dataset;
a target variable that contains a name of a dependent variable present in said initial dataset; and
optionally, a weight that contains the name of a sample weight variable present in initial dataset; and
performing a feature selection process that produces:
a correlation table that contains correlation values of correlated pairs;
a coverage table that contains a percentage of non-missing values for every feature in said initial dataset;
a feature importance table which contains significance of important features with a summary of variance inflation factor to check the correlation between continuous variables and summary of Cramer's V statistics to check the correlation between categorical variables; and
an interim dataset that contains an interim list of variables.

3. The method of claim 2,
wherein said interim dataset is a first interim data set, and
wherein said method further comprises:
sending said first interim data set to said user device; and
receiving from said user device, a second interim dataset that is a modified version of said first interim dataset.

4. The method of claim 1, further comprising, prior to performing said parametric search process:
obtaining an interim dataset and a desired quantity of clusters; and
performing a clustering process that produces:
a cluster report that contains feature groupings; and
an interim list of variables.

5. The method of claim 1, wherein said number of iterations and said parameter space are specified by a user, via said user device.

6. The method of claim 1, further comprising, after sending said report to said user device:
receiving from said user device, a communication that selects one or more of said machine learning models, thus yielding a selected model; and
storing said selected model in a memory device.

7. A system comprising:
at least one processor; and
a memory that contains instructions that are readable by said at least one processor to cause said at least one processor to optionally use multiprocessing capability to perform operations of:
receiving a training dataset, a testing dataset, a number of iterations, and a parameter space of possible parameter values that define a base model;
for said number of iterations, performing a parametric search process that produces a report that includes information concerning a plurality of machine learning models, wherein said parametric search process includes:
generating an optimized parameter space using Bayesian optimization approach for said parameter space, wherein an optimized parameter set includes training data from said training dataset, and testing data from said testing dataset;
running said base model with said optimized parameter set, thus yielding model results for said plurality of machine learning models;
calculating Kolmogorov-Smirnov (KS) statistics for said model results; and
saving said model results and said KS statistics to said report; and
sending said report to a user device.

8. The system of claim 7, wherein said operations include, prior to performing said parametric search process:
obtaining from a user device:
an initial dataset;
a target variable that contains a name of a dependent variable present in said initial dataset; and
optionally, a weight that contains the name of a sample weight variable present in initial dataset; and
performing a feature selection process that produces:
a correlation table that contains correlation values of correlated pairs;
a coverage table that contains a percentage of non-missing values for every feature in said initial dataset;
a feature importance table which contains significance of important features with a summary of variance inflation factor to check the correlation between continuous variables and summary of Cramer's V statistics to check the correlation between categorical variables; and
an interim dataset that contains an interim list of variables.

9. The system of claim 8,
wherein said interim dataset is a first interim data set, and
wherein said operations further include:
sending said first interim data set to said user device; and
receiving from said user device, a second interim dataset that is a modified version of said first interim dataset.

10. The system of claim 7, wherein said operations include, prior to performing said parametric search process:
obtaining an interim dataset and a desired quantity of clusters; and
performing a clustering process that produces:
a cluster report that contains feature groupings; and
an interim list of variables.

11. The system of claim 7, wherein said number of iterations and said parameter space are specified by a user, via said user device.

12. The system of claim 7, wherein said operations include, after sending said report to said user device:
receiving from said user device, a communication that selects one or more of said machine learning models, thus yielding a selected model; and
storing said selected model in a memory device.

13. A storage device comprising instructions that are readable by a processor to cause said processor to perform operations of:
receiving a training dataset, a testing dataset, a number of iterations, and a parameter space of possible parameter values that define a base model;
for said number of iterations, performing a parametric search process that produces a report that includes information concerning a plurality of machine learning models, wherein said parametric search process includes:
generating an optimized parameter space using Bayesian optimization approach for said parameter space, wherein an optimized parameter set includes training data from said training dataset, and testing data from said testing dataset;
running said base model with said optimized parameter set, thus yielding model results for said plurality of machine learning models;
calculating Kolmogorov-Smirnov (KS) statistics for said model results; and
saving said model results and said KS statistics to said report; and
sending said report to a user device.

14. The storage device of claim 13, wherein said operations include, prior to performing said parametric search process:
obtaining from a user device:
an initial dataset;
a target variable that contains a name of a dependent variable present in said initial dataset; and
optionally, a weight that contains the name of a sample weight variable present in initial dataset; and
performing a feature selection process that produces:
a correlation table that contains correlation values of correlated pairs;
a coverage table that contains a percentage of non-missing values for every feature in said initial dataset;
a feature importance table which contains significance of important features with a summary of variance inflation factor to check the correlation between continuous variables and summary of Cramer's V statistics to check the correlation between categorical variables; and
an interim dataset that contains an interim list of variables.

15. The storage device of claim 14,
wherein said interim dataset is a first interim data set, and
wherein said operations further include:
sending said first interim data set to said user device; and
receiving from said user device, a second interim dataset that is a modified version of said first interim dataset.

16. The storage device of claim 13, wherein said operations include, prior to performing said parametric search process:
obtaining an interim dataset and a desired quantity of clusters; and
performing a clustering process that produces:
a cluster report that contains feature groupings; and
an interim list of variables.

17. The storage device of claim 13, wherein said number of iterations and said parameter space are specified by a user, via said user device.

18. The storage device of claim 13, wherein said operations include, after sending said report to said user device:
receiving from said user device, a communication that selects one or more of said machine learning models, thus yielding a selected model; and
storing said selected model in a memory device.
